(19) United States
(12) Patent Application Publication
(10) Pub. No.: US 2005/0056349 A1
(43) Pub. Date: Mar. 17, 2005

(54) Hydrogen absorbing alloy for alkaline storage battery, method for manufacturing the same and alkaline storage battery

(76) Inventors: Shigekazu Yasuoka, Kobe-city (JP); Jun Ishida, Kobe-city (JP)

Correspondence Address: KUBOVCIK & KUBOVCIK, SUITE 710, 900 17TH STREET NW, WASHINGTON, DC, 20006, US

(21) Appl. No.: 10/937,786

(22) Filed: Sep. 10, 2004

(30) Foreign Application Priority Data
Sep. 12, 2003 (JP) 2003-321915
Aug. 11, 2004 (JP) 2004-234666

(51) Int. Cl. H01M 4/58; C22C 30/00

(52) U.S. Cl. 148/442; 429/218.2; 420/900

(57) ABSTRACT

A hydrogen absorbing alloy for a negative electrode in which a layer having at least a 10 weight % oxygen concentration is formed on a surface of particles of the alloy, and the magnesium concentration of the layer is 3.0˜7.5 times as great as that in the central part of the particles where the oxygen concentration is less than 10 weight %.

### FIELD OF THE INVENTION

The present invention relates to a hydrogen absorbing alloy for a negative electrode of an alkaline storage battery, to a method for manufacturing the hydrogen absorbing alloy, and to an alkaline storage battery including the negative electrode. More particularly, the present invention relates to an improvement in cycle life in an alkaline storage battery including a negative electrode prepared from hydrogen absorbing alloy particles containing a rare-earth element, magnesium, nickel and aluminum.

### BACKGROUND OF THE INVENTION

A nickel-cadmium storage battery has been commonly used as an alkaline storage battery. However, a nickel-hydrogen storage battery that uses a hydrogen absorbing alloy for a negative electrode has recently received attention because it has a high capacity as compared to the nickel-cadmium storage battery, and it is excellent from the view point of protecting the environment because it does not use cadmium.

Nickel-hydrogen storage batteries have been used for portable equipment. It is required to improve the batteries so that they are highly efficient.

As an alloy to be used for the negative electrode of a nickel-hydrogen storage battery, a rare earth-nickel hydrogen absorbing alloy having a crystal structure of the CaCu₅ type as the main phase, and a Laves phase hydrogen absorbing alloy containing Ti, Zr, V and Ni, and the like, having a crystal structure of the AB₂ type have been commonly used.

However, such hydrogen absorbing alloys do not have sufficient hydrogen absorbing capacity, and it is difficult to increase the capacity of the nickel-hydrogen storage battery.

A rare earth-nickel hydrogen absorbing alloy containing Mg having a crystal structure of the Ce₂Ni₇, CeNi₃, or the like type, has been proposed to increase the hydrogen absorbing capacity (for example, Japanese Patent Laid-open publication Nos. 2002-69554 and 2002-164045).

The hydrogen absorbing alloy having such crystal structure tends to be oxidized, compared to the rare earth-nickel hydrogen absorbing alloy having the crystal structure of the CaCu₅ type as the main phase, and oxidation progresses inside of particles of the hydrogen absorbing alloy when charge and discharge are repeated to deteriorate the cycle life.

### OBJECT OF THE INVENTION

An object of the present invention is to solve the above-described problems of an alkaline storage battery including a hydrogen absorbing alloy containing a rare-earth element, magnesium, nickel and aluminum as a negative electrode.

That is, an object of the present invention is to make it possible to improve the cycle life of the battery by preventing oxidizing inside of particles of the hydrogen absorbing alloy containing a rare-earth element, magnesium, nickel and aluminum when the battery is repeatedly charged and discharged.

### SUMMARY OF THE INVENTION

In the hydrogen absorbing alloy of the present invention, a layer having at least a 10 weight % oxygen concentration is formed on a surface of particles of the alloy, and the magnesium concentration of the layer is 3.0˜7.5 times as much as that in the central part of the particles where the oxygen concentration is less than 10 weight % to solve the above-described problem.

In an alkaline storage battery of the present invention including a positive electrode, a negative electrode comprising a hydrogen absorbing alloy, and an alkaline electrolyte, the above-described hydrogen absorbing alloy is used as the hydrogen absorbing alloy of the negative electrode.

### BRIEF DESCRIPTION OF THE DRAWINGS

FIG. 1 is an X-ray diffraction pattern of a hydrogen absorbing alloy used in the preparation of alloys A˜E used in Examples 1˜3 and Comparative Examples 1 and 2 before dipping in a solution of potassium hydroxide.

FIG. 2 is a cross section of an alkaline storage battery prepared in Examples 1˜3 and Comparative Examples 1 and 2.

FIG. 3 is a graph showing O₂ concentration (weight %) after activation and after 150 cycles relative to distance (SiO₂ conversion) from the surface of particles in Example 1 and Comparative Examples 2.

### EXPLANATION OF ELEMENTS

1: positive electrode
2: negative electrode
3: separator
4: battery can
5: positive electrode current collector
6: seal plate
7: negative electrode current collector
8: insulation packing
9: positive electrode external terminal
10: coil spring

### DETAILED EXPLANATION OF THE INVENTION

When the magnesium concentration in the surface layer of the particles where the oxygen concentration is at least 10 weight % is at least three times as much as that of the central part of the particles where the oxygen concentration is less than 10 weight %, a magnesium oxide or hydroxide having low solubility in an alkaline electrolyte exists on the surface of the particles and oxidation of the inside of the particles is prevented. However, if the magnesium concentration in the surface layer is too great, the rate of absorbing and releasing of hydrogen in the hydrogen absorbing alloy becomes slow and charge and discharge characteristics of the battery are deteriorated. Therefore, the magnesium concentration in the surface layer is preferred to be not greater than 7.5 times as much as that in the central portion of the particles.

If the hydrogen absorbing alloy particles have a crystal structure other than that of the CaCu₅ type, hydrogen absorbing capacity of the hydrogen absorbing alloy is increased as explained above and it is possible to obtain an alkaline storage battery having high capacity. A hydrogen absorbing alloy represented by the formula Ln₁₋ₓMgₓNi_{y-a}Alₐ (where Ln is at least one element selected from rare earth elements, 0.15≦x<0.19, 3≦y≦3.5 and 0≦a≦0.3) has high capacity. If the alloy is used, cycle life is improved and an alkaline storage battery having high capacity and long life can be obtained.

The hydrogen absorbing alloy particles for the alkaline storage battery can be prepared by dipping, or immersing, hydrogen absorbing alloy particles described above (typically having an average particle diameter in the range of 20-80 μm) in an alkaline solution or an acid solution. To prevent the hydrogen absorbing alloy particles from reacting with the alkaline electrolyte in the alkaline storage battery, it is preferable to use an alkaline solution for treatment. More preferably, the hydrogen absorbing alloy particles are immersed in a sodium hydroxide solution at a temperature of about 25° to 45° C. for a period of about 30 to 60 minutes. The thickness of the layer having at least a 10 weight % oxygen concentration and a magnesium concentration that is 3.0˜7.5 times that in the portion of the particles where the oxygen concentration is less than 10 weight % obtained under these conditions will generally be about 0.5 to 1.0% of the diameter of the particles.

### EFFECTS OF THE INVENTION

When the hydrogen absorbing alloy particles of the present invention are used for the alkaline storage battery, even if the battery is repeatedly charged and discharged, cycle life of the battery is improved and charge and discharge characteristics are prevented from being deteriorated due to inhibition of the progress of oxidation toward the inside of the particles.

### DESCRIPTION OF PREFERRED EMBODIMENTS

Examples of preparation of a hydrogen absorbing alloy for an alkaline storage battery and an alkaline storage battery prepared from the hydrogen absorbing alloy of the present invention are described below and are compared with those of comparative examples to show that an improved cycle life is obtained in the alkaline storage battery of the present invention without reduction of capacity of the battery. It is of course understood that the present invention is not limited to these examples and can be modified within the spirit and scope of the appended claims.

(Preparation of Hydrogen Absorbing Alloys A˜E for Alkaline Storage Battery)

A hydrogen absorbing alloy ingot comprising La, Pr and Nd as rare earth elements, and Mg, Ni and Al in a suitable mole ratio (La:Pr:Nd:Mg:Ni:Al) was prepared in a fusion furnace. The ingot was treated at 1000° C. for 10 hours under an argon atmosphere to prepare an hydrogen absorbing alloy ingot. The ingot was found by ICP analysis to have the formula La_{0.17}Pr_{0.34}Nd_{0.34}Mg_{0.17}Ni_{3.10}Al_{0.20}.

Then the ingot was mechanically ground under an inert gas, and was classified to obtain a hydrogen absorbing alloy powder having the formula La_{0.17}Pr_{0.34}Nd_{0.34}Mg_{0.17}Ni_{3.10}Al_{0.20} and an average particle diameter of 55 μm.

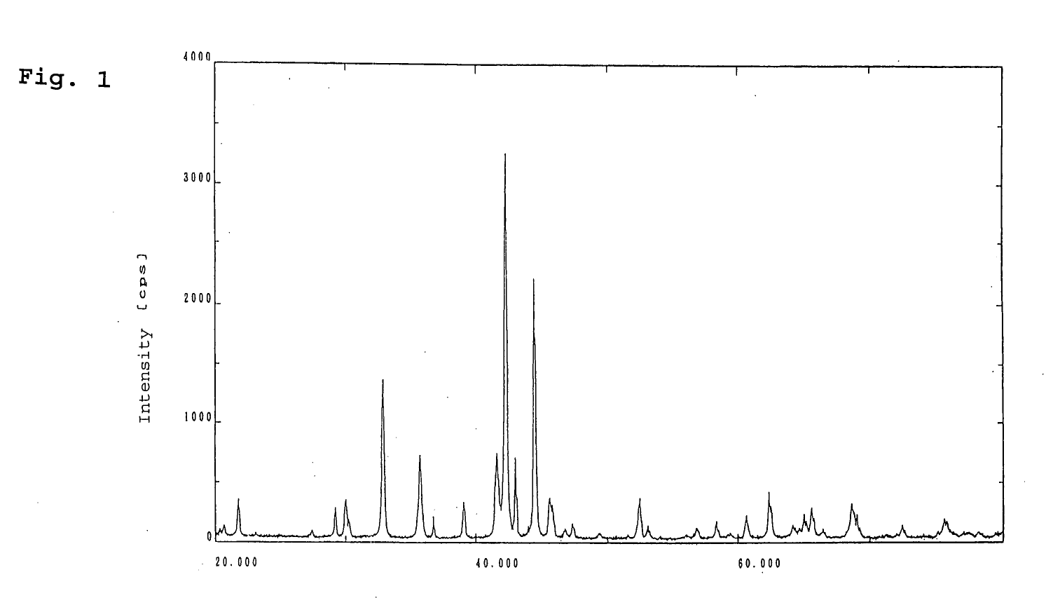

The hydrogen absorbing alloy powder was further crushed in a mortar to prepare samples for X-ray diffraction analysis. An X-ray diffraction pattern was obtained using CuK_{α}-radiation as the X-ray source, 1°/min of scanning speed, 40 kV of X-ray tube voltage and 40 mA of X-ray tube current. The results are shown in FIG. 1. The pattern approximately corresponds to a peak of a crystal structure of the Ce₂Ni₇ type, and not a crystal structure of the CaCu₅ type.

The powders of hydrogen absorbing alloys A˜D were dipped in 8N potassium hydroxide solution, and the powder of hydrogen absorbing alloy E was used without being treated with an alkaline solution.

The alloy powders A˜D were treated using 8N potassium hydroxide solution of different temperatures and different dipping times in the solution as follows:
Alloy Powder A: 25° C., 60 min.
Alloy Powder B: 45° C., 30 min.
Alloy Powder C: 45° C., 60 min., and
Alloy Powder D: 80° C., 60 min.

The treated powders were washed with water and were dried to obtain hydrogen absorbing alloys A˜D for an alkaline storage battery.

After etching the hydrogen absorbing alloys A˜E by argon ion irradiation (gun) at 80 Å/min etching speed (according to SiO₂ conversion), oxygen concentration of each of the alloys analyzed by a scanning Auger electron spectroscopy Analyzer (PHI: Model 670Xi) was obtained and thickness (according to SiO₂ conversion) of the surface layer having at least 10 weight % was obtained. The results are shown in Table 1.

Average magnesium concentration in the surface layer where the oxygen concentration is at least 10 weight % (Cs) of the hydrogen absorbing alloys A˜E and that in the central portion where the oxygen concentration is less than 10 weight % (Co) of alloy A˜E were obtained and a ratio of Cs/Co was calculated. The results are shown in Table 1.

TABLE 1

| | | | Thickness of | |
|---|---|---|---|---|
| | Alloy Treatment Condition | | Surface Layer | Mg |
| | Temperature | Time | (SiO₂ | Concentration |
| Alloy | (° C.) | (min.) | conversion) | Ratio (Cs/Co) |
| A | 25 | 60 | 25 nm | 3.0 |
| B | 45 | 30 | 35 nm | 6.3 |
| C | 45 | 60 | 48 nm | 7.5 |
| D | 80 | 60 | 72 nm | 12.8 |
| E | — | — | 20 nm | 2.1 |

The ratio Cs/Co of alloys A˜C is in a range of 3.0˜7.5 which is the range required in the present invention. The ratio Cs/Co of alloys D and E is not in the range.

(Alkaline Storage Batteries in Examples 1˜3 and Comparative Examples 1 and 2)

Alkaline storage batteries were prepared using alloys A, B and C for negative electrodes in Examples 1, 2 and 3, respectively. Alkaline storage batteries were prepared using alloys D and E for negative electrodes in Comparative Examples 1 and 2, respectively.

[Preparation of Negative Electrode]

100 Parts by weight of the hydrogen absorbing alloy, 0.4 part by weight of sodium polyacrylate, 0.1 part by weight of carboxymethylcellulose and 2.5 parts of a 60 weight % polytetrafluoroethylene dispersion were mixed to prepare a paste. The paste was applied on both sides of an electrically-conductive core material comprising a nickel plated punching metal having a thickness of 60 μm, which was pressed after drying and cut to a desired (predetermined) size, as a negative electrode.

[Preparation of Positive Electrode]

Nickel hydroxide powder containing 2.5 weight % of zinc and 1.0 weight % of cobalt was added into a cobalt sulfate solution, 1 mol sodium hydroxide solution was gradually dropped into the cobalt sulfate solution including nickel hydroxide with stirring and reacted until the pH reached 11. Then, the precipitate was filtered, washed with water, and vacuum dried to obtain nickel hydroxide coated with cobalt hydroxide. 25 weight % sodium hydroxide solution was added to the nickel hydroxide coated with cobalt hydroxide to a ratio by weight of the nickel hydroxide coated with cobalt hydroxide to the sodium hydroxide solution of 1:10 and was immersed. After the mixture was reacted at 85° C. for 8 hours with stirring, a positive electrode material in which the surface of nickel hydroxide was coated with cobalt oxide containing sodium was obtained.

95 parts by weight of the positive electrode material, 3 parts by weight of zinc oxide and 2 parts by weight of cobalt hydroxide were mixed and 50 parts by weight of 0.2 weight % hydroxypropylcellulose were added to prepare a slurry. The slurry was filled in a nickel foam, pressed after drying and cut to a desired (predetermined) size to prepare a non-sintered nickel electrode as a positive electrode.

[Separator and Electrolyte]

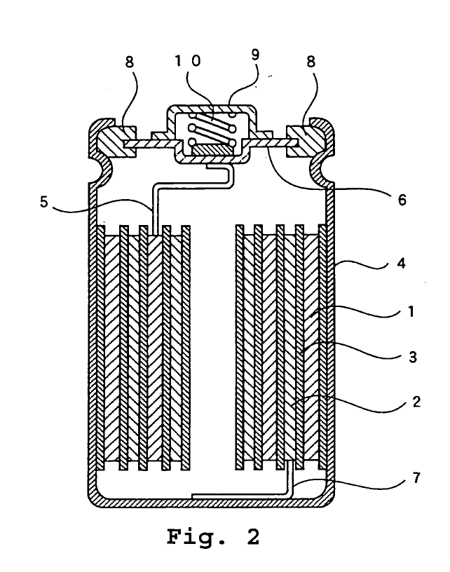

A polypropylene nonwoven fabric was used as a separator. 30 weight % of an alkaline electrolyte containing KOH, NaOH and LiOH·H₂O in a ratio of 8:0.5:1 by weight was used. Cylindrical alkaline storage batteries of Examples 1˜3 and Comparative Examples 1 and 2 having a designed capacity of 1500 mA as shown in FIG. 2 were assembled.

As shown in FIG. 2, the separator 3 was inserted between the positive electrode 1 and the negative electrode 2 and was spirally rolled, and was placed in a battery can 4. 2.4 g of the alkaline electrolyte was poured into the battery can 4 and the can was sealed after an insulation packing 8 was placed between the battery can 4 and a seal plate 6. The positive electrode 1 was connected to the seal plate 6 through a positive electrode current collector (positive electrode lead) 5, and the negative electrode 2 was connected to the battery can 4 through a negative electrode current collector (negative electrode lead) 7. The battery can 4 and seal plate 6 were electrically insulated by the insulation packing 8. A coil spring 10 was placed between the seal plate 6 and a positive electrode external terminal 9. The coil spring 10 is compressed and releases gas from inside of the battery to the atmosphere when pressure in the battery unusually increases.

The batteries of Examples 1˜3 and Comparative Examples 1 and 2 were charged at 150 mA for 16 hour and then discharged to a battery voltage of 1.0 V at 1500 mA (this charge and discharge cycle is considered one cycle). Charge and discharge of the batteries were repeated three times to activate the batteries.

Discharge capacities at the third cycle of batteries (Qₒ) of Examples 1˜3 and Comparative Examples 1 and 2 were obtained. The results are shown in Table 2 as an index when the discharge capacity (Qₒ) of the battery of Comparative Example 2 is taken as 100.

After the batteries of Examples 1˜3 and Comparative Examples 1 and 2 were activated as described above, the batteries were charged at 150 mA for 16 hours, and were left for three hours at 0° C. Then the batteries were discharged to 1.0 V of battery voltage at 3000 mA to obtain discharge capacities of the batteries at high current after the batteries were left standing at a low temperature. The discharge capacities (Q_{c}) of the batteries are shown in Table 2 as an index when the discharge capacity (Q_{c}) of the battery of Comparative Example 2 is taken as 100.

The batteries were charged at 1500 mA to the maximum voltages and then were discharged to 1.0 V (this charge and discharge cycle is considered one cycle). 150 cycles were repeated.

After initial activation of the batteries and after 150 cycles, the hydrogen absorbing alloy powders were taken out from the batteries, then the alloy powders were etched by argon ion irradiation (gun) at an etching speed of 80 Å/min with SiO₂ conversion, oxygen concentration of each of the alloy powders was analyzed by a scanning Auger electron spectroscopy Analyzer (PHI: Model 670Xi). Oxygen concentration (weight %) at 400 nm (SiO₂ conversion) from the surface was obtained. The results are shown in Table 2.

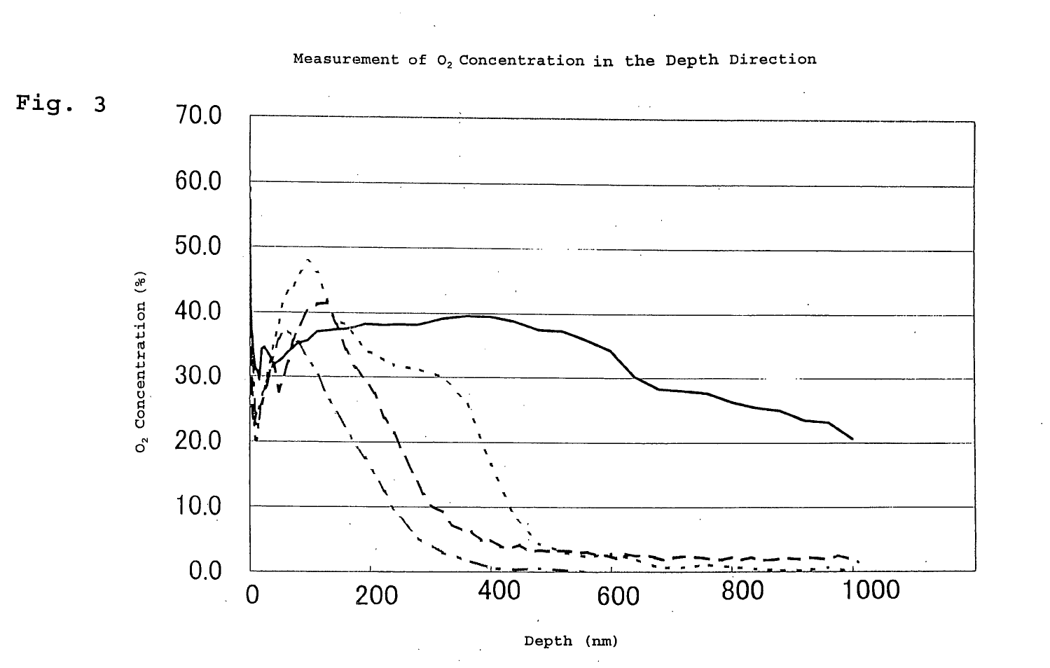

Relationship between the distance from the surface (SiO₂ conversion) and oxygen concentration (weight %) of the alloy powders of the batteries of Example 1 and Comparative Example 2 are shown in FIG. 3. In FIG. 3, the results after initial activation of Example 1 are shown with a dash dot line, the results after 150 cycles of Example 1 are shown with a dotted line. In FIG. 3, the results after initial activation of Comparative Example 2 are shown with a dashed line, the results after 150 cycles of Example 1 are shown with a solid line.

TABLE 2

| | | | | | Oxygen | |
|---|---|---|---|---|---|---|
| | | | | | concentration | |
| | | | | | (weight %) | |
| | | Mg | | | | After |
| | | Concentration | | | After | 150 |
| | Alloy | Ratio (Cs/Co) | Qo | Qc | activation | cycles |
| Example 1 | A | 3 | 101 | 98 | 0.6 | 20.5 |
| Example 2 | B | 6.3 | 100 | 94 | 0.5 | 9.4 |
| Example 3 | C | 7.5 | 99 | 92 | 0.8 | 16.6 |
| Comparative | D | 12.8 | 97 | 18 | 4.9 | 9.4 |
| Example 1 | | | | | | |
| Comparative | E | 2.1 | 100 | 100 | 0.7 | 39.5 |
| Example 2 | | | | | | |

As is clear from the results, in the alkaline storage battery prepared using hydrogen absorbing alloy D of Comparative Example 1 having a Cs/Co ratio greater than 7.5, i.e., 12.8, discharge capacity (Qc) at a high current after storage at a low temperature was significantly decreased compared to Examples 1˜3 and Comparative Example 2 and discharge characteristics are deteriorated.

In the alkaline storage battery prepared using hydrogen absorbing alloy E of Comparative Example 2 having a Cs/Co ratio of not greater than 3.0, i.e., 2.1, oxygen concentration is high inside of the hydrogen absorbing alloy powder after 150 cycles compared to Examples 1˜3 and Comparative Example 1. That is, oxidation progressed inside of the alloy, the alloy was deteriorated, and cycle life was deteriorated.

1. A hydrogen absorbing alloy for a negative electrode of an alkaline storage battery, comprising particles of a hydrogen absorbing alloy containing a rare-earth element, magnesium, nickel and aluminum, said particles having a surface layer having an oxygen concentration of at least 10 weight % and a magnesium concentration that is 3.0˜7.5 times as great as a magnesium concentration at a central portion of the particles where the oxygen concentration is less than 10 weight %.

2. The hydrogen absorbing alloy according to claim 1, wherein a crystal structure of the particles of the hydrogen absorbing alloy is other than a CaCu₅ type crystal structure.

3. A method for preparing a hydrogen absorbing alloy for a negative electrode of an alkaline storage battery, comprising contacting particles of a hydrogen absorbing alloy containing a rare-earth element, magnesium, nickel and aluminum, with an alkaline solution to form a surface layer on the particles of the hydrogen absorbing alloy, said surface layer having an oxygen concentration of at least 10 weight % and a magnesium concentration that is 3.0˜7.5 times as great as a magnesium concentration at a central portion of the particles where the oxygen concentration is less than 10 weight %.

4. The method of claim 3, wherein a crystal structure of the particles of the hydrogen absorbing alloy is other than a CaCu₅ type crystal structure.

5. An alkaline storage battery comprising a positive electrode, a negative electrode and an alkaline electrolyte, wherein the negative electrode comprises the hydrogen absorbing alloy according to claim 1.

6. An alkaline storage battery comprising a positive electrode, a negative electrode and an alkaline electrolyte, wherein the negative electrode comprises the hydrogen absorbing alloy according to claim 2.
